(19) United States
(12) Patent Application Publication
(10) Pub. No.: US 2019/0121910 A1
(43) Pub. Date: Apr. 25, 2019

(54) SYSTEMS AND METHODS FOR SOCIAL CONTENT DISCOVERY AND CONSUMPTION

(71) Applicant: Facebook, Inc., Menlo Park, CA (US)

(72) Inventor: Alex Douglas Cornell, San Francisco, CA (US)

(21) Appl. No.: 15/791,847

(22) Filed: Oct. 24, 2017

(51) Int. Cl. G06F 17/30

(52) U.S. Cl. CPC G06F 17/30867; G06F 3/0482; G06F 17/30554

(57) ABSTRACT

Systems, methods, and non-transitory computer-readable media can provide a plurality of content item recommendations for a first user in a content discovery interface. The content discovery interface comprises a content item recommendation portion comprising the plurality of content item recommendations, and a first social lens portion comprising a first plurality of social lenses. A content item is provided in a content consumption interface. The content consumption interface comprises a playback portion, a second social lens portion comprising a second plurality of social lenses, and a social interaction portion.

### FIELD OF THE INVENTION

The present technology relates to the field of social networking systems. More particularly, the present technology relates to systems and methods for social content discovery and consumption.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

### SUMMARY

Various embodiments of the present disclosure can include systems, methods, and non-transitory computer readable media configured to provide a plurality of content item recommendations for a first user in a content discovery interface. The content discovery interface comprises a content item recommendation portion comprising the plurality of content item recommendations, and a first social lens portion comprising a first plurality of social lenses. A content item is provided in a content consumption interface. The content consumption interface comprises a playback portion, a second social lens portion comprising a second plurality of social lenses, and a social interaction portion.

In an embodiment, the plurality of content item recommendations are determined based on a selection of a first social lens of the first plurality of social lenses.

In an embodiment, the first social lens is associated with a second user, and at least a subset of the first plurality of content item recommendations is included in the first plurality of content item recommendations based on a determination that each content item recommendation of the subset of the first plurality of content item recommendations may be relevant to the first user and the second user.

In an embodiment, the first social lens is associated with a first group, and at least a subset of the first plurality of content item recommendations is included in the first plurality of content item recommendations based on a determination that each content item recommendation of the subset of the first plurality of content item recommendations may be relevant to the first user and the first group.

In an embodiment, the first plurality of social lenses comprises one or more group social lenses generated based on one or more groups with which the user is associated.

In an embodiment, the second plurality of social lenses comprises the one or more group social lenses.

In an embodiment, selection of a first group social lens associated with a first group within the second social lens portion causes a page associated with the first group to be presented within the social interaction portion.

In an embodiment, the first plurality of social lenses comprises one or more messaging social lenses generated based on previous messaging sessions involving the first user.

In an embodiment, the second plurality of social lenses comprises the one or more messaging social lenses.

In an embodiment, selection of a first messaging social lens associated with a first set of users within the second social lens portion causes a messaging session between the first user and the first set of users to be presented within the social interaction portion.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a social consumption module, according to an embodiment of the present disclosure.

FIG. 2 illustrates an example content discovery module, according to various embodiments of the present disclosure.

FIG. 3 illustrates an example content consumption module, according to various embodiments of the present disclosure.

FIG. 4A illustrates an example scenario associated with social content discovery, according to an embodiment of the present disclosure.

FIGS. 4B-F illustrate an example scenario associated with social content consumption, according to an embodiment of the present disclosure.

FIG. 5 illustrates an example method associated with social content discovery and consumption, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Social Content Discovery and Consumption

People use computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be provided with a user interface to view and interact with the social networking system. For example, the user interface may be provided via a mobile application or via a web browser. The user interface can provide users with the ability to view and otherwise interact with content on the social networking system, such as content items posted to the social networking system by other users. For example, a user can view photos and videos or listen to audio files posted by other users. The user interface can also provide users with the ability to interact with other users on the social networking system. For example, a user can send messages to other users, or comment on content items posted by other users.

It continues to be an important interest for a social networking system to encourage interaction between users and content on the social networking system. Continued user interaction with content posted to the social networking and with other users on the social networking system is an important aspect of maintaining continued interest in and participation on the social networking system. A related issue is the issue of providing users with graphical user interfaces that allow users to interact with the social networking system in an interesting and intuitive manner. Under conventional approaches, it has been a challenge to provide user interfaces and features that encourage both content consumption and social interaction on a social networking system. For example, even if users are able to easily consume content posted to the social networking system, such consumption of content may generally be a solitary activity and may not be experienced as a shared social interaction involving other users on the social networking system.

An improved approach rooted in computer technology overcomes the foregoing and other disadvantages associated with conventional approaches specifically arising in the realm of computer technology. In general, a user can be presented with a content discovery interface in which one or more content items, such as videos, can be recommended to the user for viewing. The content discovery interface can present a user with a set of content item recommendations (e.g., video recommendations) that the user can select for viewing. The content discovery interface can also include a social lens portion comprising a plurality of social lenses. Each social lens may be associated with a particular entity or set of entities. For example, a first social lens may be associated with all users on a social networking system, a second social lens may be associated with a particular group of users on a social networking system, and a third social lens may be associated with one or more friends of a user on the social networking system. The set of content item recommendations presented to a user can vary based on which social lens has been selected by the user. For example, if a user selects a first social lens associated with a first friend, the set of content item recommendations may comprise content items that are determined to potentially be of interest to the user and the first friend. If the user selects a second social lens associated with a second friend, the set of content item recommendations may comprise content items that are determined to potentially be of interest to the user and the second friend, and so forth.

The user can select a particular content item from the set of content item recommendations to open a content consumption interface within which the user can consume the content item. For example, the content consumption interface may include a video playback portion within which the user can view a video. In various embodiments, the content consumption interface can comprise a playback portion and a social interaction portion. The social interaction portion can be configured to allow a user to interact with one or more other users about a content item being presented in the playback portion. The content consumption interface can further comprise a social lens portion. The social lens portion may be identical to and/or substantially similar to the social lens portion from the content discovery interface. Within the content consumption interface, the social lens portion can allow a user to select one or more entities or sets of entities to interact with within the social interaction portion. Other features and advantages of the present disclosure are described in greater detail herein.

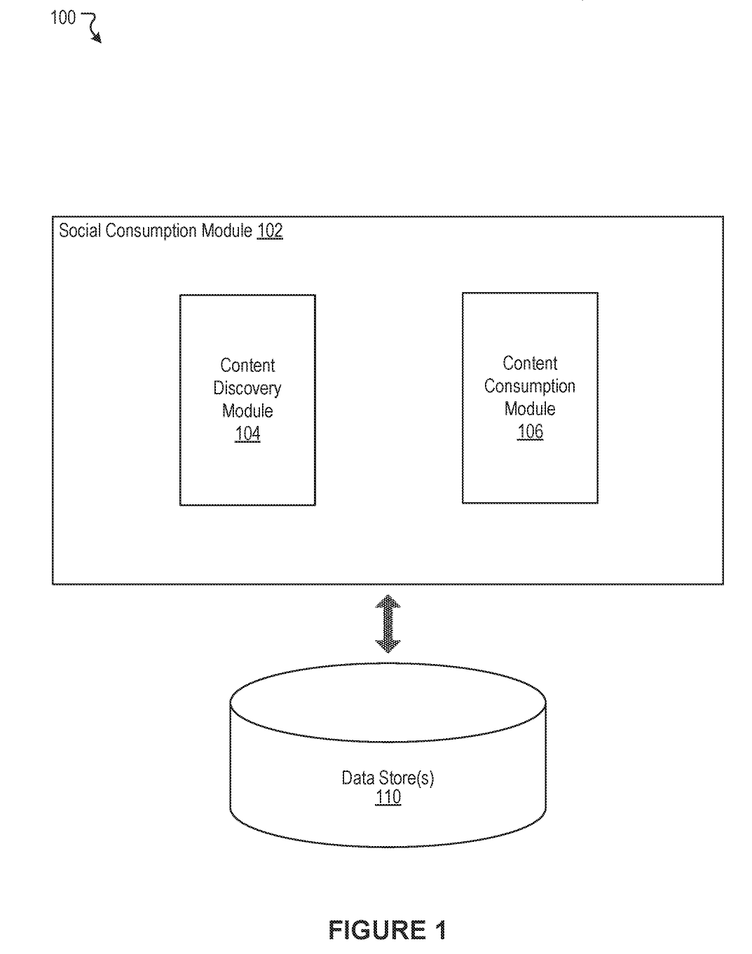

FIG. 1 illustrates an example system 100 including an example social consumption module 102, according to an embodiment of the present disclosure. The social consumption module 102 can be configured to provide a content discovery interface within which a user can be provided with a plurality of content item recommendations. The social consumption module 102 can also be configured to provide a content consumption interface within which a user can consume a content item and interact with other users about the content item.

In various embodiments, the content discovery interface can comprise a social lens portion comprising a plurality of social lenses. Each social lens can be associated with a particular entity or set of entities. The social consumption module 102 can be configured to identify and present a set of content item recommendations to a user based on a social lens selected within the social lens portion. In various embodiments, the social consumption module 102 can be configured to identify one or more content item recommendations that may be of interest to the user and the one or more entities associated with the selected social lens. As the user selects different social lenses within the social lens portion, the social consumption module 102 can present different sets of content item recommendations to the user based on which social lens is selected. The user can select a particular content item from a set of content item recommendations to cause the social consumption module 102 to open a content consumption interface for consuming the content item.

In various embodiments, the content consumption interface can comprise a playback portion, a social interaction portion, and a social lens portion. The playback portion can present a content item (e.g., play back a video). The social interaction portion can allow a user to interact with other users about the content item being presented in the playback portion. The social lens portion can be identical to and/or substantially similar to the social lens portion that was presented in the content discovery interface. While the social lens portion is displayed within both the content discovery interface and the content consumption interface, it may serve a different function within each interface. As discussed above, within the content discovery interface, the social lens portion can allow a user to switch between different sets of content item recommendations that are tailored for the user and different sets of entities. Within the content consumption interface, the social lens portion can allow a user to select different sets of entities with which to interact about the content item being presented in the playback portion. For example, the user can select a first social lens associated with a first friend. The social consumption module 102 can provide within the social interaction portion a messaging session between the user and the first friend so that the user can interact with the first friend about the content item being presented. In another example, the user can select a second social lens associated with a group comprising a plurality of users. The social consumption module 102 can provide within the social interaction portion an interface within which the user can post messages to the group about the content item. In this way, the social consumption module 102 can provide a user with content item recommendations that can act as a starting point for interactions between the user and other users, and also provides a seamless transition from content discovery to content consumption within which the user can interact with other users about the content item being consumed.

As shown in the example of FIG. 1, the social consumption module 102 can include a content discovery module 104 and a content consumption module 106. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the social consumption module 102 can be implemented in any suitable combinations.

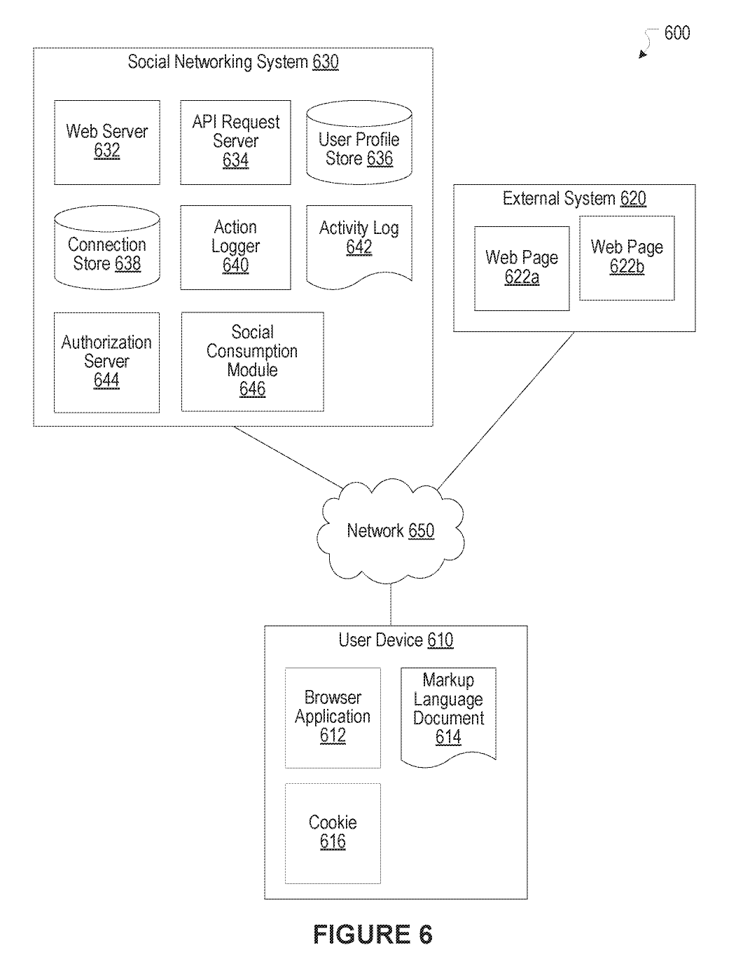

In some embodiments, the social consumption module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the social consumption module 102 can be implemented, in part or in whole, as software running on one or more computing devices or systems, such as on a user or client computing device. For example, the social consumption module 102, or at least a portion thereof, can be implemented as or within an application (e.g., app), a program, or an applet, etc., running on a user computing device or a client computing system, such as the user device 610 of FIG. 6. In another example, the social consumption module 102, or at least a portion thereof, can be implemented using one or more computing devices or systems that include one or more servers, such as network servers or cloud servers. In some instances, the social consumption module 102 can, in part or in whole, be implemented within or configured to operate in conjunction with a social networking system (or service), such as the social networking system 630 of FIG. 6. It should be understood that there can be many variations or other possibilities.

The social consumption module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social engagements, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the social consumption module 102. For example, the data store 110 can store content items, messaging session information, user interest information, user interaction information, user affinity information, and the like. It is contemplated that there can be many variations or other possibilities.

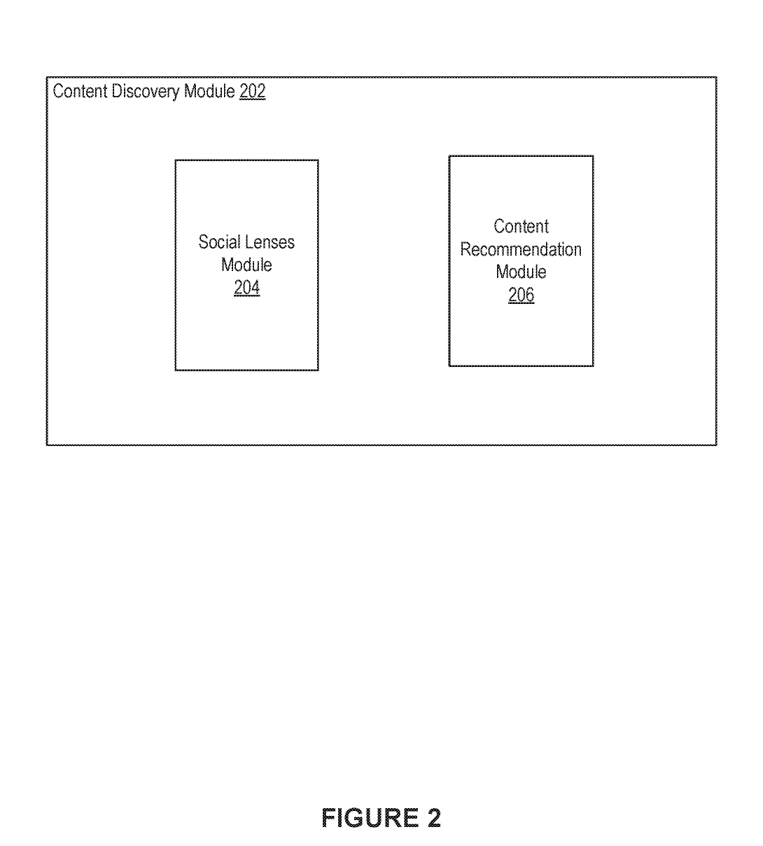

The content discovery module 104 can be configured to provide a content discovery interface to a user. The content discovery interface can comprise a content item recommendation portion and a social lens portion. As introduced above, the social lens portion can comprise a plurality of social lenses, and each social lens can be associated with a particular entity of set of entities. The content item recommendation portion can comprise a plurality of content item recommendations. The content discovery module 104 can be configured to determine a set of content item recommendations for a user based on a social lens selected within the social lens portion. The content discovery module 104 is described in greater detail herein with reference to FIG. 2.

The content consumption module 106 can be configured to provide a content consumption interface to a user. The content consumption interface can comprise a playback portion, a social interaction portion, and a social lens portion. The social lens portion can be substantially similar to and/or identical to the social lens portion presented in the content discovery interface. When a user selects a particular content item from a set of content item recommendations presented in the content discovery interface, the content item can be presented in the playback portion. The social interaction portion can be configured to allow a user to interact with other users about the content item being presented in the playback portion.

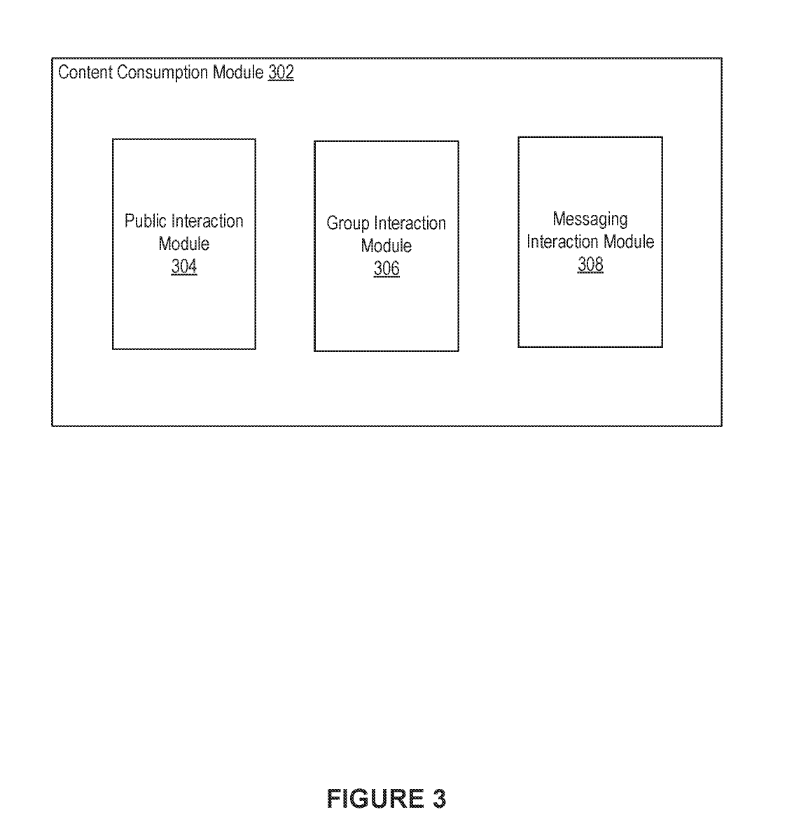

Various aspects of the social interaction portion can be configured based on a social lens selected within the social lens portion. In one example, the set of users that the user can interact with within the social interaction portion may be determined based on which social lens is selected. In another example, a user interaction format may be determined based on which social lens is selected. For example, if a social lens is associated with one or more friends of the user, the interaction format may comprise a messaging session between the user and the one or more friends. In another example, if a social lens is associated with a group on a social networking system (e.g., a common interest group) comprising a plurality of users, the interaction format can comprise a wall associated with the group on which the user can post a message for the group. In yet another example, if a social lens is associated with all users on a social networking system or is otherwise designated as a “public” social lens, the interaction format can comprise a comment wall on which the user can post a public comment to the content item. The content consumption module 106 is described in greater detail herein with reference to FIG. 3.

FIG. 2 illustrates an example content discovery module 202 configured to provide a content discovery interface to a user, according to an embodiment of the present disclosure. In some embodiments, the content discovery module 104 of FIG. 1 can be implemented as the content discovery module 202. As shown in the example of FIG. 2, the content discovery module 202 can include a social lenses module 204 and a content recommendation module 206.

The social lenses module 204 can be configured to populate and provide a social lens portion of a content discovery interface. The social lens portion can comprise a plurality of social lenses, and each social lens can be associated with one or more entities on a social networking system. The social lenses module 204 can be configured to generate social lenses based on various social lens criteria. For example, the social lenses module 204 can generate one or more default social lenses. Default social lenses might include, for example, a “popular” social lens identifying content items that are popular amongst users on a social networking system, a “trending” social lens identifying content items that are trending on a social networking system, a “friends” social lens identifying content items that are popular amongst a user's friends on a social networking system, and/or a “following” social lens identifying content items that are popular amongst and/or posted by users that a user follows on a social networking system.

The social lenses module 204 can also be configured to generate social lenses based on user interaction information. For example, social lenses can be generated for each friend or group of friends with which a user has an active messaging session. In another example, social lenses can be generated for each group on a social networking system to which the user belongs.

The social lenses module 204 can also be configured to rank a set of social lenses based on social lens ranking criteria. Social lenses can be presented within the social lens portion based on the ranking. In one embodiment, the ranking criteria may rank one or more default social lenses before any other social lenses, such that default social lenses (e.g., popular, trending, friends, and/or following social lenses) are presented first within the social lens portion. In various embodiments, the ranking criteria can comprise ranking a set of social lenses based on user interaction information. For example, if a user has a higher messaging coefficient (or affinity) and/or interaction coefficient with a particular user, that particular user may be upranked compared to another user with which the user has a lower messaging and/or interaction coefficient. A messaging coefficient may be indicative of how frequently a user exchanges messages with another user, and an interaction coefficient may be indicative of how frequently a user interacts with another user on the social networking system. In various embodiments, the ranking criteria for a plurality of social lenses can be based on a quantity of content item recommendations identified for each social lens. As will be described in greater detail below, a set of content item recommendations can be identified for each social lens based on various recommendation criteria. In certain embodiments, the ranking criteria can uprank social lenses that satisfy a minimum content item recommendation threshold, and can downrank and/or filter out social lenses that do not satisfy the minimum content item recommendation threshold.

The content recommendation module 206 can be configured to populate and provide to a user a content item recommendation portion of a content discovery interface. When a user selects a social lens, a set of content item recommendations can be provided to the user based on the selected social lens. As described above, a social lens can be associated with one or more entities. The content recommendation module 206 can be configured to identify a set of content items that may be of interest and/or relevant to both the user and the one or more entities associated with a selected social lens. For example, if a user selects a first social lens that is labeled “Popular” and is associated with all users on a social networking system, the user can be presented with a set of content items that are popular amongst users on the social networking system. If the user selects a second social lens associated with a first friend of the user, the user can be presented with a set of content items that are determined to be potentially of interest and/or relevant to the user and the first friend (e.g., based on shared mutual interests or previous interactions between the user and the first friend). If the user selects a third social lens associated with a group on a social networking system, such as a group devoted to drones, the user can be presented with a set of content items that are determined to be relevant to the user and to the group (e.g., a set of videos about drones, or a set of videos that have been posted to the group's page on a social networking system). Many variations are possible.

The set of content items can be presented in the content item recommendation portion as content item recommendations. In various embodiments, the content item recommendation module 206 can be configured to rank a set of content item recommendations based on content ranking criteria. The set of content item recommendations can be presented based on the ranking. For example, a set of content item recommendations can be ranked based on a popularity of each content item, how recently a content item was posted, a likelihood that the user will view the content item, a likelihood that the user will interact with one or more other users about the content item, and the like.

FIG. 3 illustrates an example content consumption module 302 configured to provide a content consumption interface to a user, according to an embodiment of the present disclosure. In some embodiments, the content consumption module 106 of FIG. 1 can be implemented as the content consumption module 302. As shown in the example of FIG. 3, the content consumption module 302 can include a public interaction module 304, a group interaction module 306, and a messaging interaction module 308.

A content consumption interface can include a playback portion, a social lens portion, and a social interaction portion. The playback portion can be configured to present a content item. The social lens portion can present a plurality of social lenses, and can be substantially similar to and/or identical to the social lens portion of the content discovery interface described above. The social interaction portion can allow a user to interact with other users about a content item being presented in the playback portion. The social interaction portion can vary depending on a social lens selected within the social lens portion. The public interaction module 304, the group interaction module 306, and the messaging interaction module 308 can be configured to present a different type of interaction format within the social interaction portion based on a type and/or category of a selected social lens.

The public interaction module 304 can be configured to provide a public interaction format within the social interaction portion. As introduced above, certain social lenses may be categorized as “public” social lenses. Public social lenses may be associated with a particular interaction format. For example, public social lenses can be associated with the interaction format of a public comment wall. When a user selects a public social lens in the social lens portion of a content consumption interface, the social interaction portion can present a public comment wall for a content item being presented in the playback portion. As such, the user can view comments that were previously posted for the content item, and can post his or her own public comment to the comment wall.

The group interaction module 306 can be configured to provide a group interaction format within the social interaction portion. As referenced above, certain social lenses may be categorized as “group” social lenses. For example, any social lens associated with a formally defined group on a social networking system may be categorized as a group social lens. In certain embodiments, a social networking system group may comprise a plurality of users that have joined and/or become members of the group. In certain embodiments, the group may be associated with a dedicated presence (e.g., a “page”) on the social networking system associated with the group, and one or more administrator users who are given special permissions to manage the group. Group social lenses may be associated with a particular interaction format. In certain embodiments, the interaction format may be a page associated with the group. When a user selects a group social lens associated with a group, the social interaction portion can present a page associated with the group such that the user can view previous messages posted to the page and can post his or her own messages to the page. In certain embodiments, if a user viewing the page within the social interaction portion indicates a desire to interact with the page (e.g., by clicking on an element on the page), the playback portion can be shrunken and/or minimized to allow the user to more easily interact with the page.

The messaging interaction module 308 can be configured to provide a messaging interaction format within the social interaction portion. Certain social lenses may be categorized as “messaging” social lenses. For example, any social lens associated with a previously existing messaging session between a user and one or more other users can be categorized as a messaging social lens. In certain embodiments, a social lens associated with one or more friends of a user and/or one or more friends of friends of a user may be categorized as a messaging social lens. Messaging social lenses may be associated with a particular interaction format. For example, in one embodiment, the interaction format may be a messaging session. When a user selects a messaging social lens associated with one or more users, the messaging interaction module 308 can be configured to present within the social interaction portion a messaging session between the user and the one or more users. For example, the messaging session can be a pseudo real-time messaging session and/or an instant messaging session. In certain embodiments, when a content item is being presented within the playback portion of a content consumption interface for a user, the social interaction portion may provide the user with an option to share the content item, or access to the content item, within the messaging session. In various embodiments, the messaging session may also provide an indication that one or more other users began consuming (e.g., playing) the content item within the messaging session. The users can exchange messages within the messaging session, for example, to discuss the content item.

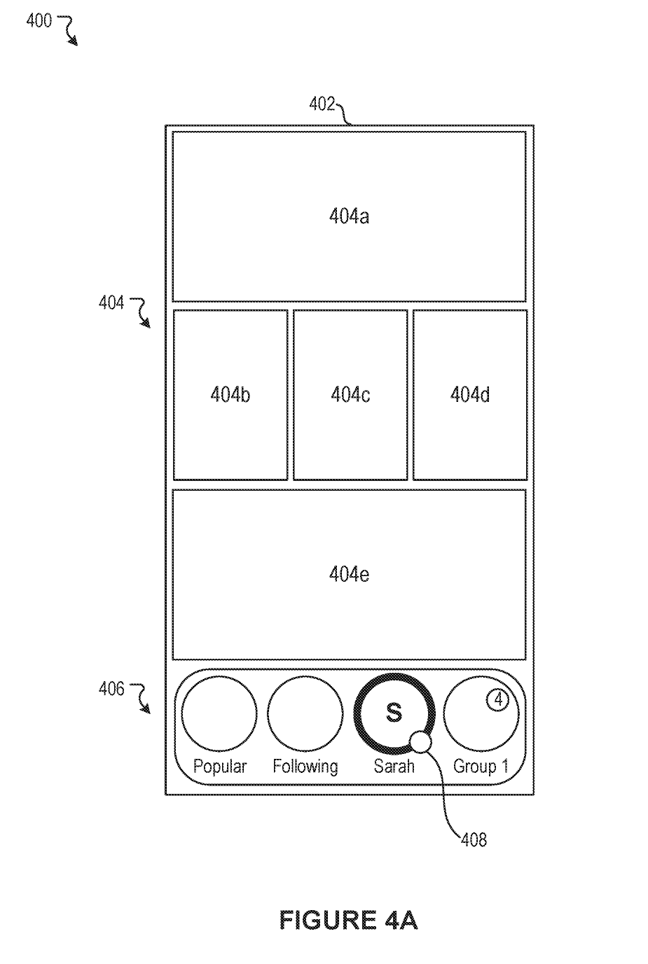

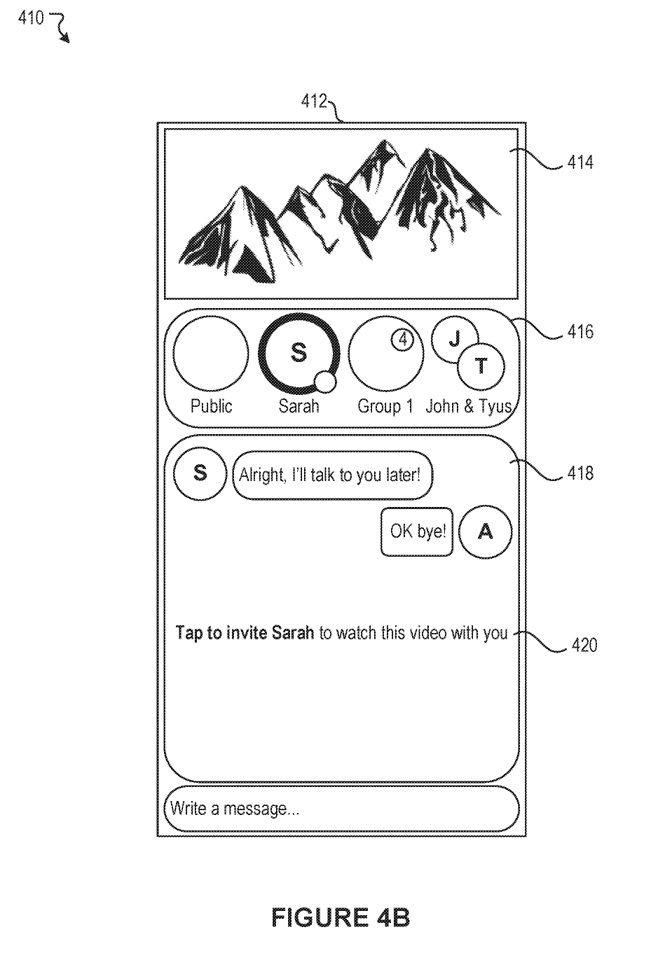

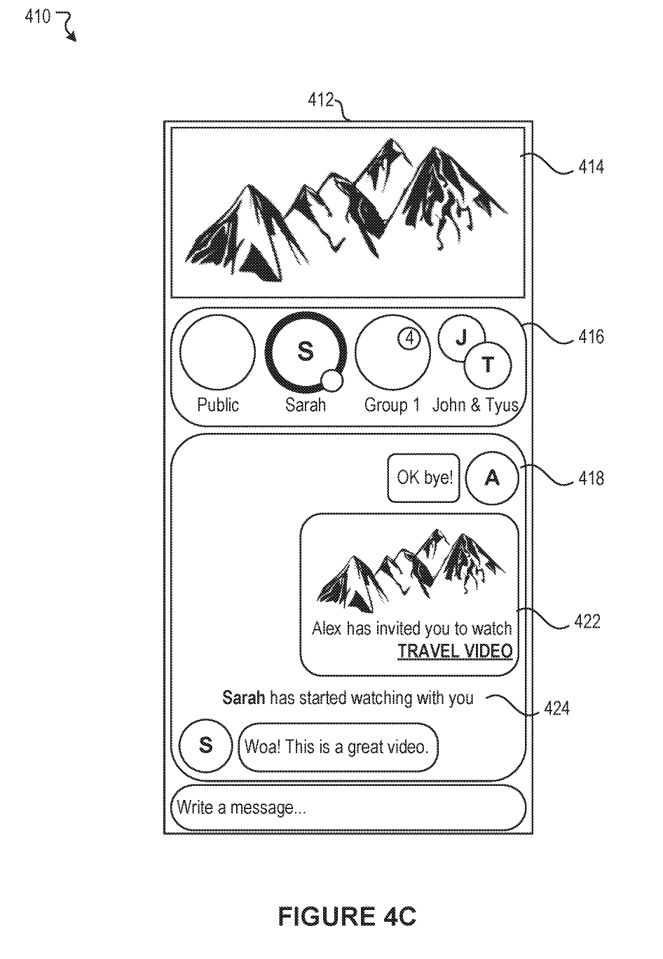

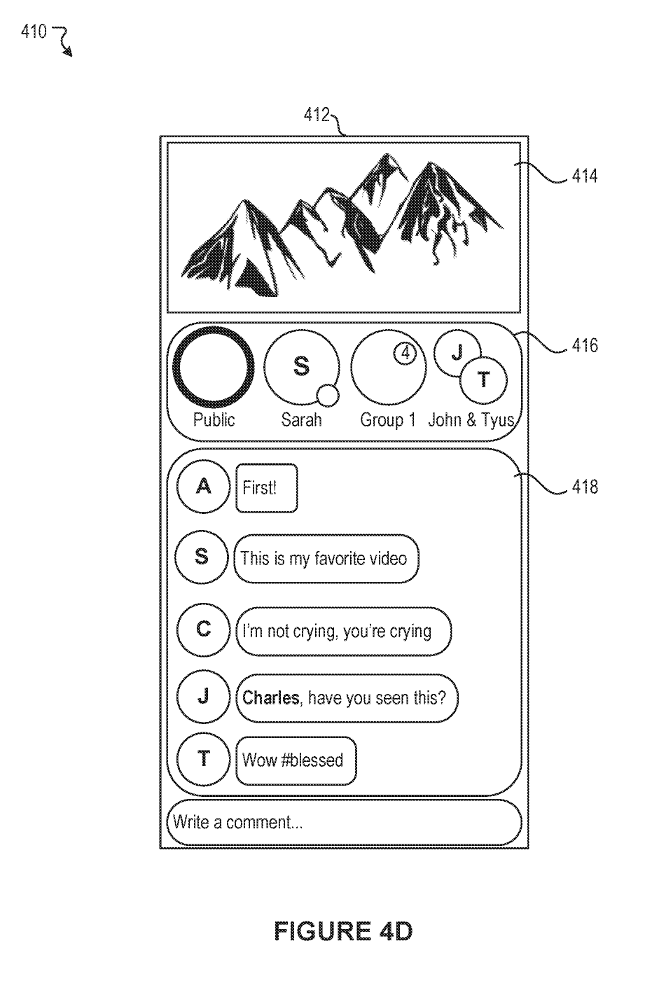

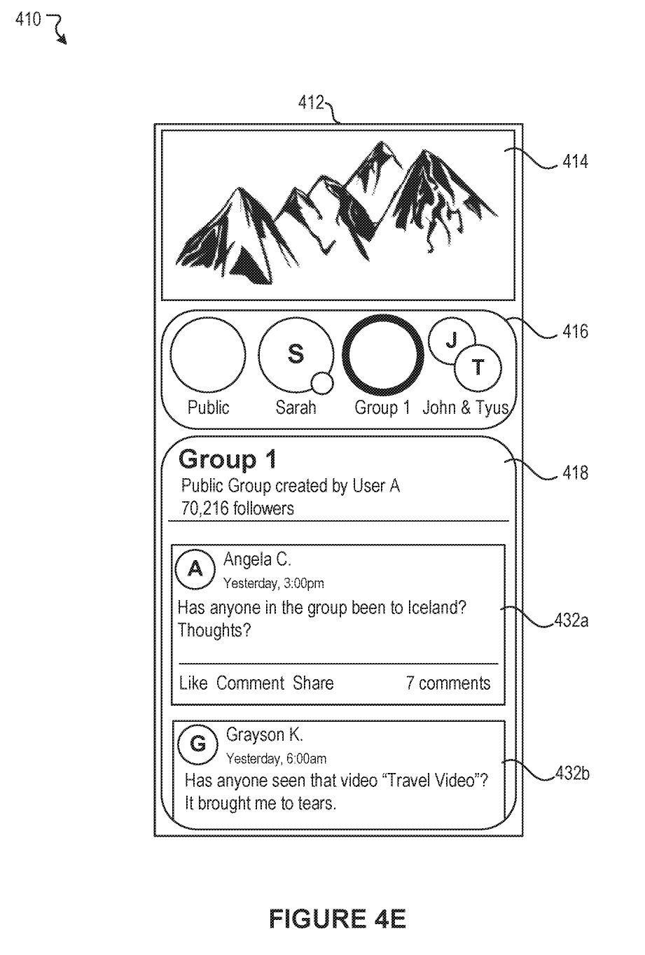

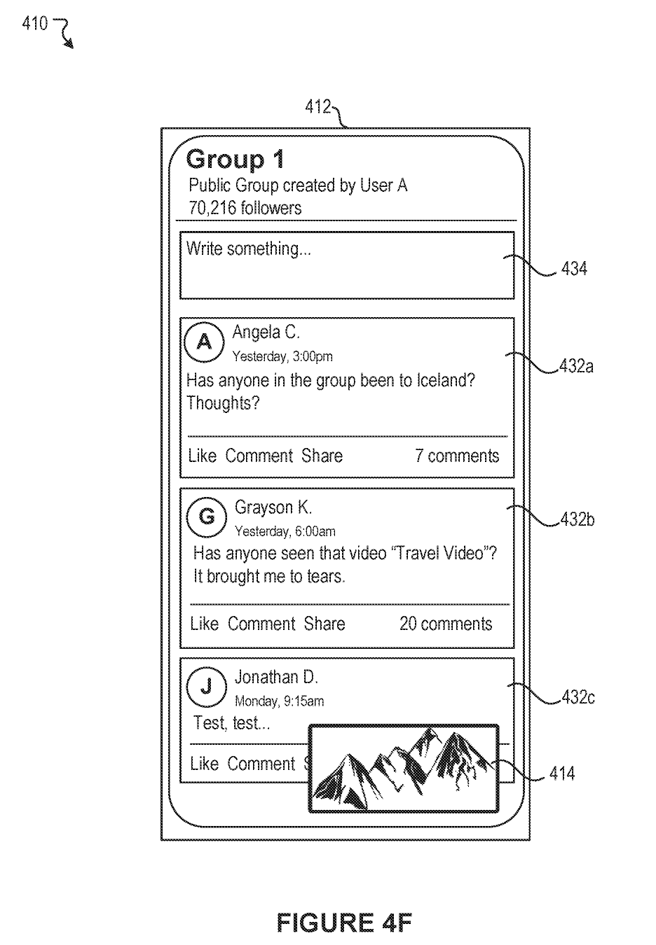

FIG. 4A illustrates an example scenario 400 associated with providing a content discovery interface, according to an embodiment of the present disclosure. The example scenario 400 includes a content discovery interface 402 comprising a content item recommendation portion 404 and a social lens portion 406. As an example, the social lens portion 406 includes four social lenses: a “Popular” social lens, a “Following” social lens, a social lens associated with a user Sarah, and a social lens associated with a group, Group 1. In certain embodiments, the “Popular” and “Following” social lenses may be default social lenses generated for all users. The social lens associated with the user Sarah may have been generated based on a previous messaging session and/or a messaging affinity between a current user and the user Sarah. The social lens associated with the group, Group 1, may have been generated based on the current user's membership and/or participation in the group Group 1. A bold outline shown in relation to the social lens associated with Sarah indicates that the user has currently selected the social lens associated with the user Sarah. The social lens can include a smaller circular status indicator 408 indicative of whether, for example, the user Sarah is active, idle, and/or inactive on a messenger platform. For example, the status indicator may be different colors depending on the user's status.

The content item recommendation portion 404 presents a plurality of content item recommendations 404a-404e. The content item recommendations 404a-404e may comprise content item recommendations that were identified based on the user's selection of the social lens associated with the user Sarah. For example, the content item recommendations 404a-404e may comprise a plurality of content items determined to potentially be of interest and/or relevant to both the user and to Sarah. In certain embodiments, the content item recommendations may be ranked based on content ranking criteria and presented in an order based on the ranking. Selection of a different social lens may result in a different set of content item recommendations being presented. The user can select a particular content item recommendation 404a-404e to open a content consumption interface to view/consume the selected content item recommendation.

FIGS. 4B-4F illustrate an example scenario 410 associated with providing a content consumption interface, according to an embodiment of the present disclosure. The example scenario 410 includes a content consumption interface 412 comprising a playback portion 414, a social lens portion 416, and a social interaction portion 418. The playback portion 414 presents a content item that has been selected by a user from the content discovery interface 402 of FIG. 4A. The social lens portion 416 is substantially similar to the social lens portion 406 of FIG. 4A. In the social lens portion 416, all of the “public” social lenses (i.e., the “popular” social lens and the “following” social lens) have been collapsed into a single “public” social lens. It can be seen that in FIG. 4B, the user continues to select the social lens associated with the user Sarah. This social lens is associated with a particular user or a particular set of users, and is categorized as a “messaging” social lens associated with a particular interaction format. As such, the social interaction portion 418 presents a messaging session between the user and Sarah. The messaging session includes previous messages exchanged between the users (i.e., “Alright, I'll talk to you later!” and “OK bye!”). The messaging session also includes a message 420 allowing the user to invite Sarah to watch the content item being presented in the playback portion 414.

In FIG. 4C, the user has tapped on the message 420, and a new message 422 indicates that the user (Alex) has invited Sarah to watch the content item, which is a video entitled “TRAVEL VIDEO.” Another message 424 is automatically generated when Sarah begins watching the shared video, and indicates to the user Alex that Sarah has begun watching the video. Alex and Sarah can exchange messages with one another within the messaging session in the social interaction portion 418. For example, Sarah has responded with the message “Woa! This is a great video.”

In FIG. 4D, the user has now selected the “Public” social lens in the social lens portion 416. The social interaction portion 418 is updated based on the new social lens selection. The public social lens is associated with a particular interaction format. In this case, that interaction format is a public comment wall for the content item being presented in the playback portion 414. As such, the social interaction portion 418 presents public comments posted by other users to the content item, and allows the user to post a public comment for the content item as well.

In FIG. 4E, the user has selected the “Group 1” social lens in the social lens portion 416. This social lens is associated with a group, Group 1. This social lens is associated with a particular interaction format. In this case, the interaction format is a page associated with the group, and messages posted to the group's page. As such, the social interaction portion 418 displays Group 1's page, and messages that have been posted to Group 1's page. The user can view and/or interact with the messages posted to Group 1's page, such as the messages 432a and 432b. The user can also post his or her own message to the page.

In FIG. 4F, the user has indicated a desire to interact with the page (e.g., by clicking on an element in the page, such as one of the messages 432a, 432b, 432c). The playback portion 414 has been minimized, and the social lens portion 416 has been removed so that the user can more easily interact with Group 1's page by, for example, posting a message to the page through a text input element 434 displayed for the user. In certain embodiments, the user can click on the playback portion 414 to go back to the layout presented in FIG. 4E. Furthermore, in various embodiments, the user can close the content consumption interface 412 (e.g., by selecting a close window element), to return to the content discovery interface 402 of FIG. 4A.

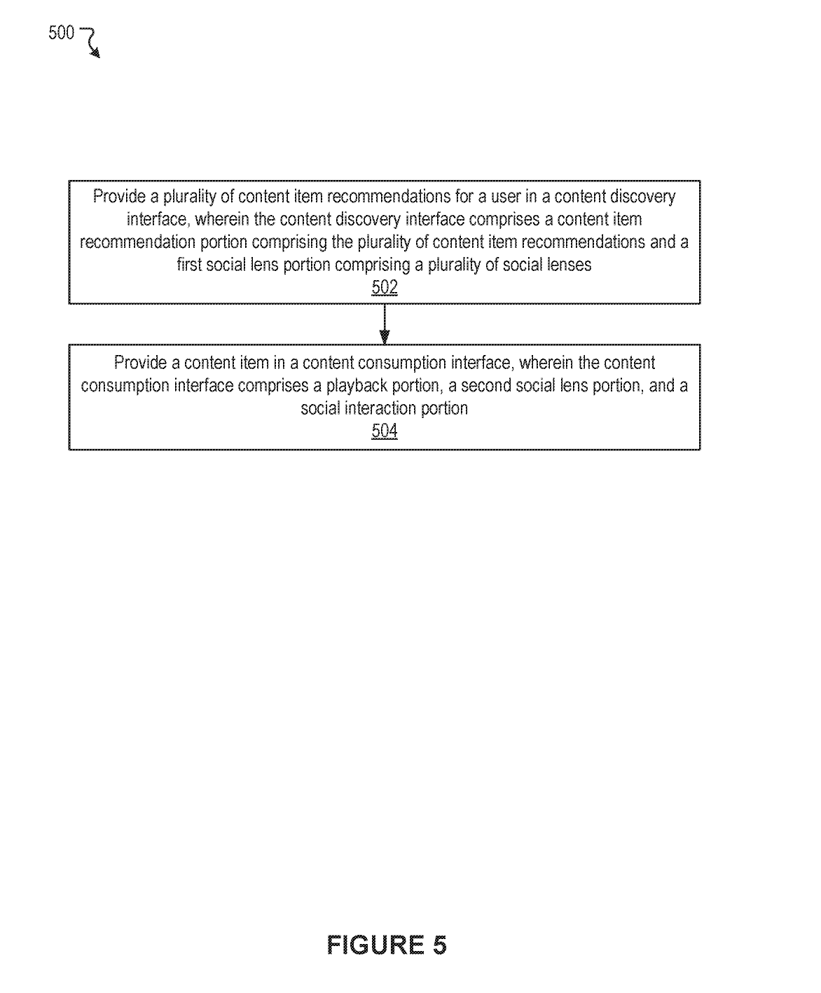

FIG. 5 illustrates an example method 500 associated with social content consumption, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can provide a plurality of content item recommendations for a user in a content discovery interface, wherein the content discovery interface comprises a content item recommendation portion comprising the plurality of content item recommendations and a first social lens portion comprising a plurality of social lenses. At block 504, the example method 500 can provide a content item in a content consumption interface, wherein the content consumption interface comprises a playback portion, a second social lens portion, and a social interaction portion.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing engagements between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and engagements with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and engagements.

The social networking system 630 also includes user-generated content, which enhances a user's engagements with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the engagement of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the engagements and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's engagement with an external system 620 from the web server 632. In this example, the external system 620 reports a user's engagement according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing engagements between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a social consumption module 646. The social consumption module 646 can, for example, be implemented as the social consumption module 102, as discussed in more detail herein. As discussed previously, it should be appreciated that there can be many variations or other possibilities. For example, in some embodiments, one or more functionalities of the social consumption module 646 can be implemented in the user device 610.

### Hardware Implementation

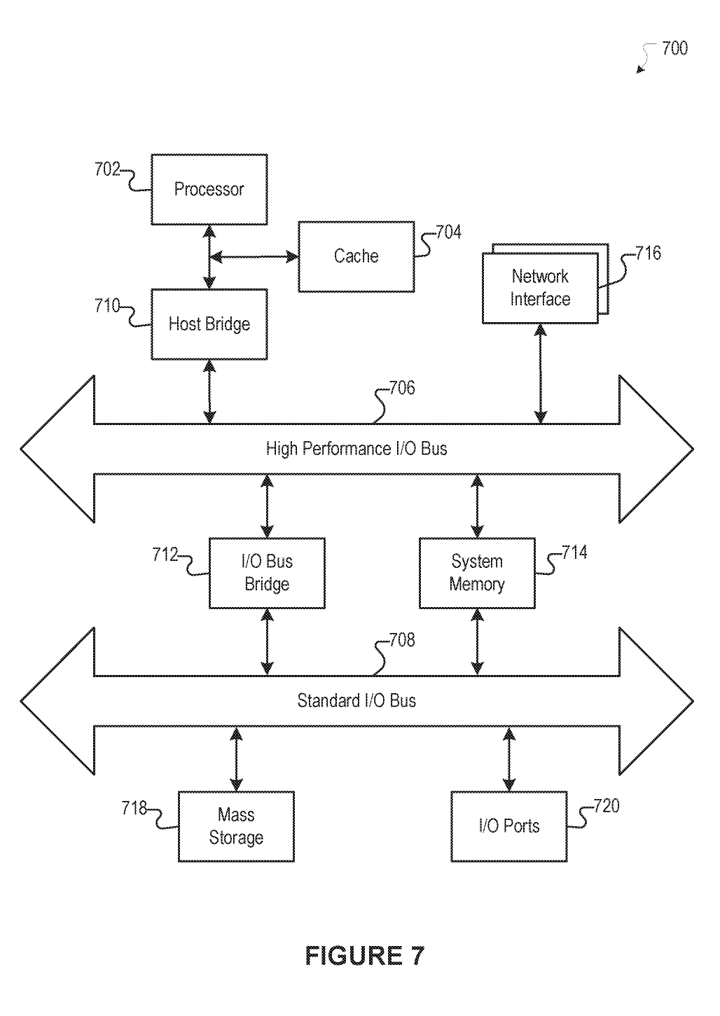

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
providing, by a computing system, a plurality of content item recommendations for a first user in a content discovery interface, wherein the content discovery interface comprises
a content item recommendation portion comprising the plurality of content item recommendations, and
a first social lens portion comprising a first plurality of social lenses; and
providing, by the computing system, a content item in a content consumption interface, wherein the content consumption interface comprises
a playback portion,
a second social lens portion comprising a second plurality of social lenses, and
a social interaction portion.

2. The computer-implemented method of claim 1, wherein the plurality of content item recommendations are determined based on a selection of a first social lens of the first plurality of social lenses.

3. The computer-implemented method of claim 2, wherein
the first social lens is associated with a second user, and
at least a subset of the first plurality of content item recommendations is included in the first plurality of content item recommendations based on a determination that each content item recommendation of the subset of the first plurality of content item recommendations may be relevant to the first user and the second user.

4. The computer-implemented method of claim 2, wherein
the first social lens is associated with a first group, and
at least a subset of the first plurality of content item recommendations is included in the first plurality of content item recommendations based on a determination that each content item recommendation of the subset of the first plurality of content item recommendations may be relevant to the first user and the first group.

5. The computer-implemented method of claim 1, wherein the first plurality of social lenses comprises one or more group social lenses generated based on one or more groups with which the first user is associated.

6. The computer-implemented method of claim 5, wherein the second plurality of social lenses comprises the one or more group social lenses.

7. The computer-implemented method of claim 6, wherein selection of a first group social lens associated with a first group within the second social lens portion causes a page associated with the first group to be presented within the social interaction portion.

8. The computer-implemented method of claim 1, wherein the first plurality of social lenses comprises one or more messaging social lenses generated based on previous messaging sessions involving the first user.

9. The computer-implemented method of claim 8, wherein the second plurality of social lenses comprises the one or more messaging social lenses.

10. The computer-implemented method of claim 9, wherein selection of a first messaging social lens associated with a first set of users within the second social lens portion causes a messaging session between the first user and the first set of users to be presented within the social interaction portion.

11. A system comprising:
at least one processor; and
a memory storing instructions that, when executed by the at least one processor, cause the system to perform a method comprising:
providing a plurality of content item recommendations for a first user in a content discovery interface, wherein the content discovery interface comprises
a content item recommendation portion comprising the plurality of content item recommendations, and
a first social lens portion comprising a first plurality of social lenses; and
providing, by the computing system, a content item in a content consumption interface, wherein the content consumption interface comprises
a playback portion,
a second social lens portion comprising a second plurality of social lenses, and
a social interaction portion.

12. The system of claim 11, wherein the plurality of content item recommendations are determined based on a selection of a first social lens of the first plurality of social lenses.

13. The system of claim 12, wherein
the first social lens is associated with a second user, and
at least a subset of the first plurality of content item recommendations is included in the first plurality of content item recommendations based on a determination that each content item recommendation of the subset of the first plurality of content item recommendations may be relevant to the first user and the second user.

14. The system of claim 12, wherein
the first social lens is associated with a first group, and
at least a subset of the first plurality of content item recommendations is included in the first plurality of content item recommendations based on a determination that each content item recommendation of the subset of the first plurality of content item recommendations may be relevant to the first user and the first group.

15. The system of claim 11, wherein the first plurality of social lenses comprises one or more group social lenses generated based on one or more groups with which the first user is associated.

16. A non-transitory computer-readable storage medium including instructions that, when executed by at least one processor of a computing system, cause the computing system to perform a method comprising:
providing a plurality of content item recommendations for a first user in a content discovery interface, wherein the content discovery interface comprises
a content item recommendation portion comprising the plurality of content item recommendations, and
a first social lens portion comprising a first plurality of social lenses; and
providing, by the computing system, a content item in a content consumption interface, wherein the content consumption interface comprises
a playback portion,
a second social lens portion comprising a second plurality of social lenses, and
a social interaction portion.

17. The non-transitory computer-readable storage medium of claim 16, wherein the plurality of content item recommendations are determined based on a selection of a first social lens of the first plurality of social lenses.

18. The non-transitory computer-readable storage medium of claim 17, wherein
the first social lens is associated with a second user, and
at least a subset of the first plurality of content item recommendations is included in the first plurality of content item recommendations based on a determination that each content item recommendation of the subset of the first plurality of content item recommendations may be relevant to the first user and the second user.

19. The non-transitory computer-readable storage medium of claim 17, wherein
the first social lens is associated with a first group, and
at least a subset of the first plurality of content item recommendations is included in the first plurality of content item recommendations based on a determination that each content item recommendation of the subset of the first plurality of content item recommendations may be relevant to the first user and the first group.

20. The non-transitory computer-readable storage medium of claim 16, wherein the first plurality of social lenses comprises one or more group social lenses generated based on one or more groups with which the first user is associated.
